(19) United States
(12) Patent Application Publication
(10) Pub. No.: US 2013/0119760 A1
(43) Pub. Date: May 16, 2013

(54) ELECTRIC VEHICULAR POWER CONTROLLER SUPPORT STRUCTURE AND ELECTRIC VEHICLE

(71) Applicant: Honda Motor Co., Ltd., Tokyo (JP)

(72) Inventors: Atsushi AMANO, Wako (JP); Ryuta WAKABAYASHI, Wako (JP); Ryoji TOMOKAGE, Wako (JP)

(73) Assignee: HONDA MOTOR CO., LTD., Tokyo (JP)

(21) Appl. No.: 13/666,971

(22) Filed: Nov. 2, 2012

(30) Foreign Application Priority Data
Nov. 14, 2011 (JP) 2011-248167

(51) Int. Cl. B60L 1/00

(52) U.S. Cl. 307/10.1

(57) ABSTRACT

An electric vehicular power controller support structure includes a sub-frame to support a power controller. The sub-frame is detachably attached to a vehicle body of an electric vehicle as a member separate from the vehicle body. The power controller is configured to control power supplied from a battery of the electric vehicle and is configured to supply the power to a motor of the electric vehicle. The sub-frame is disposed to overlap with the power controller in a position of a top-bottom direction of the electric vehicle. The sub-frame is disposed to surround the power controller as viewed from the top-bottom direction.

### CROSS-REFERENCE TO RELATED APPLICATIONS

The present application claims priority under 35 U.S.C. §119 to Japanese Patent Application No. 2011-248167, filed Nov. 14, 2011, entitled “Electric Vehicular Power Control Unit Support Structure.” The contents of this application are incorporated herein by reference in their entirety.

### BACKGROUND OF THE INVENTION

1. Field of the Invention

The present disclosure relates to an electric vehicular power controller support structure and an electric vehicle.

2. Discussion of the Background

Hitherto, in electric vehicles and the like, for example a motor and an inverter that controls the operation of the motor have been housed in a motor room disposed in the front of the vehicle body (see, for example, Japanese Unexamined Patent Application Publication No. 2011-20624). In the configuration of Japanese Unexamined Patent Application Publication No. 2011-20624, the inverter is fastened at two left and right places in the front lower part thereof and two left and right places in the rear lower part thereof to a frame.

### SUMMARY OF THE INVENTION

According to one aspect of the present invention, an electric vehicular power controller support structure includes a sub-frame to support a power controller. The sub-frame is detachably attached to a vehicle body of an electric vehicle as a member separate from the vehicle body. The power controller is configured to control power supplied from a battery of the electric vehicle and is configured to supply the power to a motor of the electric vehicle. The sub-frame is disposed to overlap with the power controller in a position of a top-bottom direction of the electric vehicle. The sub-frame is disposed to surround the power controller as viewed from the top-bottom direction.

According to another aspect of the present invention, an electric vehicle includes a power controller and a sub-frame. The power controller is configured to control power supplied from a battery of the electric vehicle and is configured to supply the power to a motor of the electric vehicle. The sub-frame is to support the power controller. The sub-frame is detachably attached to a vehicle body of the electric vehicle as a member separate from the vehicle body. The sub-frame is disposed to overlap with the power controller in a position of a top-bottom direction of the electric vehicle. The sub-frame is disposed to surround the power controller as viewed from the top-bottom direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic side view of the front part of an electric vehicle in an embodiment.

FIG. 2 is a perspective view of a PCU and a unit support frame.

FIG. 3 is a view from the direction of arrow III of FIG. 2.

FIG. 4 is a view from the direction of arrow IV of FIG. 2.

FIG. 5 is a view from the direction of arrow V of FIG. 2.

FIG. 6 is a top perspective view of a lower case.

FIG. 7 is a bottom perspective view of a heat sink housing.

### DESCRIPTION OF THE EMBODIMENTS

The embodiments will now be described with reference to the accompanying drawings, wherein like reference numerals designate corresponding or identical elements throughout the various drawings.

### Electric Vehicle

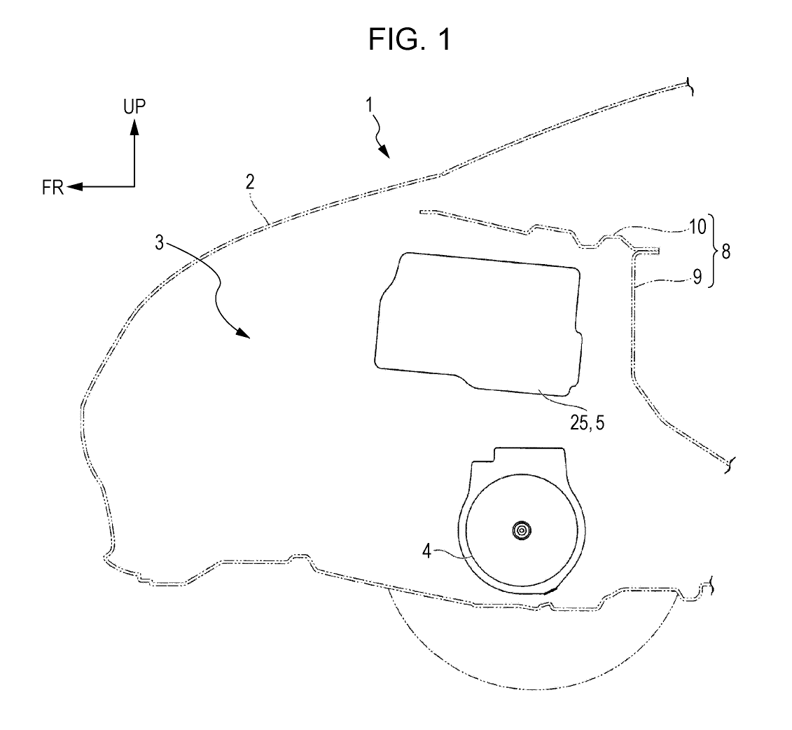

FIG. 1 is a schematic side view of the front part of an electric vehicle in this embodiment. Directions such as the front-rear direction and the left-right direction in the following description are the same as those in the vehicle unless otherwise noted.

As shown in FIG. 1, in the electric vehicle 1 of this embodiment, a motor room 3 is defined in the front part of the vehicle body 2. A motor 4 as a drive source, and a power control unit 5 (hereinafter referred to as PCU 5) that is disposed above the motor 4 and controls the operation of the motor 4 are mainly housed in the motor room 3.

A dashboard 8 that separates the inside of a vehicle interior (not shown) and the inside of the motor room 3 from each other in the front-rear direction is provided in the rear part of the motor room 3. The dashboard 8 includes a dashboard lower 9 that extends along the top-bottom direction behind the PCU 5, and a dashboard upper 10 that extends from the upper end of the dashboard lower 9 toward the front.

The motor 4 has a cylindrical shape and is elastically supported by the vehicle body 2 with a vibration isolation member (not shown) therebetween and with its rotation axis in the left-right direction.

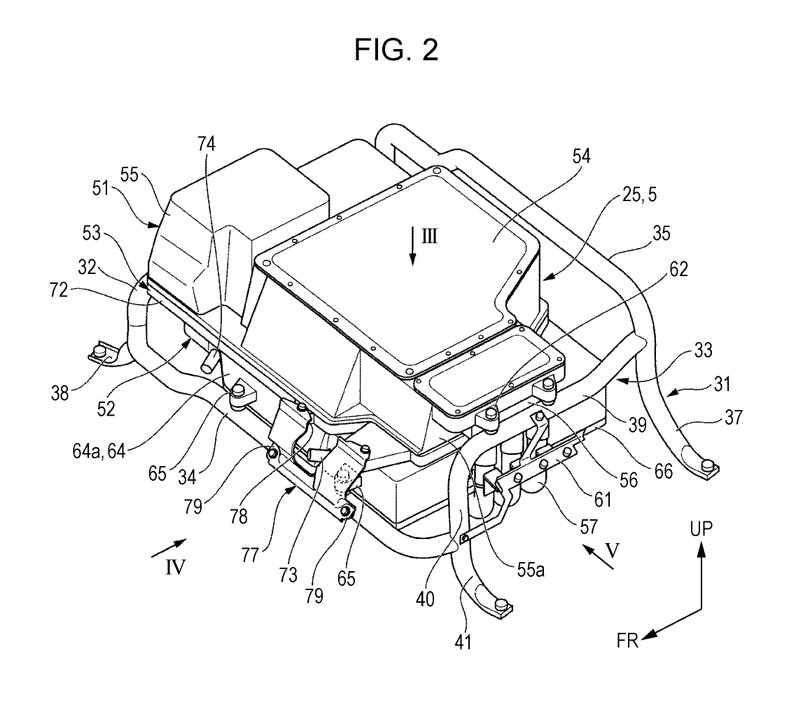

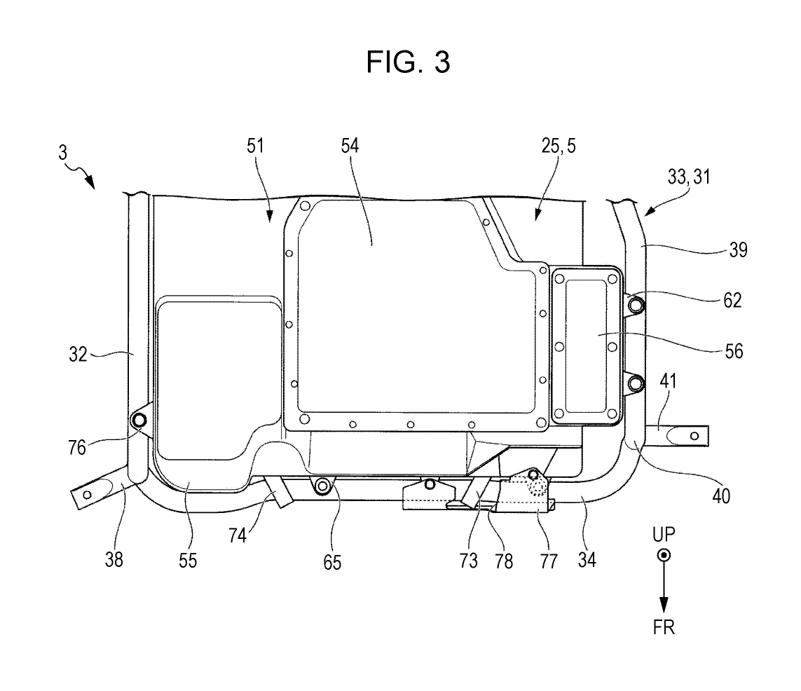

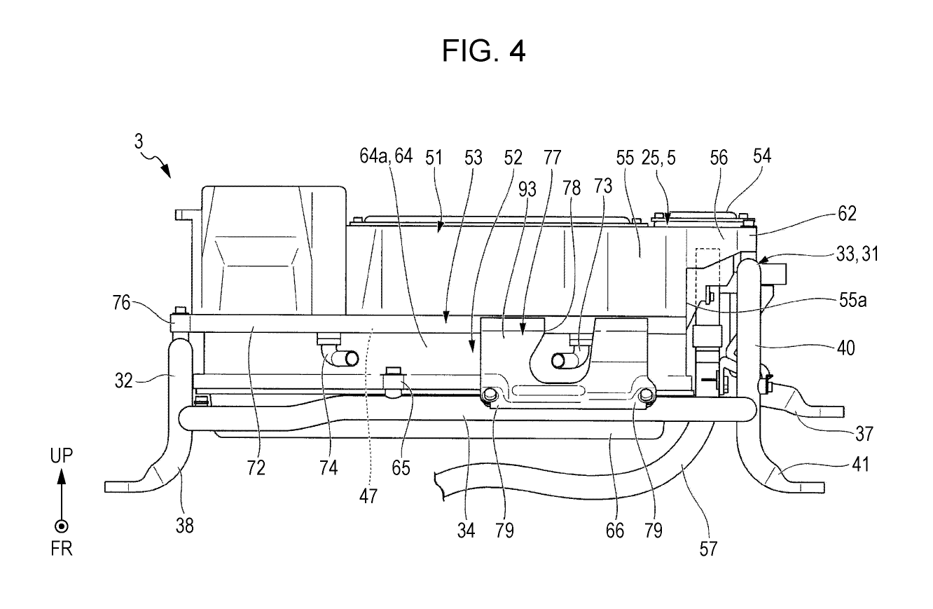

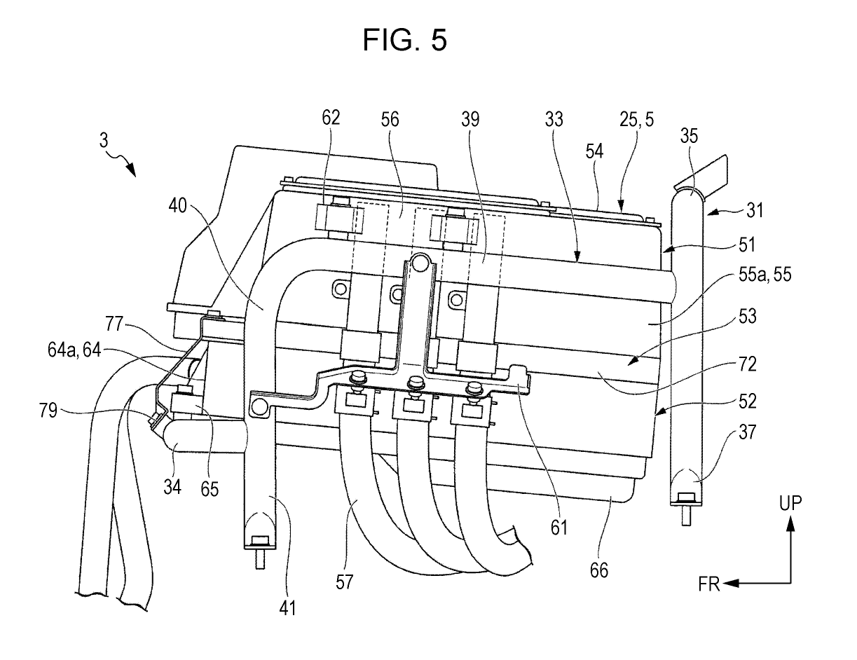

FIG. 2 is a front left perspective view of the PCU and a unit support frame. FIG. 3 is a view from the direction of arrow III of FIG. 2, FIG. 4 is a view from the direction of arrow IV of FIG. 2, and FIG. 5 is a view from the direction of arrow V of FIG. 2.

As shown in FIGS. 2 to 5, the PCU 5 converts DC power supplied from a high-voltage battery (battery) (not shown) disposed, for example, in a lower part of the vehicle interior into three-phase (U-phase, V-phase, and W-phase) AC power, supplies the resulting AC power to the motor 4, and thereby controls the operation of the motor 4. Specifically, the PCU 5 includes a box-shaped housing 25 formed in a substantially quadrilateral shape as viewed from above. Various control devices (not shown) are housed in the housing 25. The PCU 5 is supported by the vehicle body 2 with a unit support frame (sub-frame) 31 therebetween above the motor 4 in the motor room 3.

### Unit Support Frame

The unit support frame 31 is a pipe-like member detachably attached to a frame member (not shown) of the vehicle body 2. The unit support frame 31 is disposed so as to surround the entire periphery of the PCU 5, in a position where the unit support frame 31 overlaps with the PCU 5 in the top-bottom direction, in the central part in the left-right direction of the motor room 3 as viewed from the top-bottom direction. Specifically, the unit support frame 31 includes a right side support frame 32 disposed on the right side of the PCU 5, a left side support frame 33 disposed on the left side of the PCU 5, a front support frame 34 that connects the front ends of the side support frames 32 and 33, and a rear support frame 35 (see FIG. 2) that connects the rear ends of the side support frames 32 and 33.

The front support frame 34 extends along the left-right direction in front of the lower part of the housing 25, and both ends along its extending direction are bent toward the rear.

As shown in FIGS. 2 and 5, the rear support frame 35 extends along the left-right direction behind the upper part of the housing 25 of the PCU 5, and both ends along its extending direction are bent downward. The rear support frame 35 is fastened to the foregoing dashboard 8 at a plurality of places along the left-right direction. Both ends along the extending direction of the rear support frame 35 form leg portions 37 for fixing the unit support frame 31 to the frame member of the vehicle body 2. Of the leg portions 37, only the left leg portion 37 of the rear support frame 35 is shown in the figures.

As shown in FIGS. 2 to 4, the right side support frame 32 extends along the front-rear direction on the right side of the middle part in the top-bottom direction of the housing 25. The right side support frame 32 is joined to the right end of the front support frame 34 at the front end thereof, and is joined to the right end of the rear support frame 35 at the rear end thereof.

A leg portion 38 extends downward from the junction between the right side support frame 32 and the front support frame 34. The leg portion 38 extends gradually to the outer side (right side) of the PCU 5 as it extends from the upper end to the lower end. The unit support frame 31 is fixed to the frame member of the vehicle body 2 with the leg portion 38 therebetween.

The left side support frame 33 includes, on the left side of the PCU 5, a front-rear frame 39 that extends along the front-rear direction, and a top-bottom frame 40 that extends downward from the front end of the front-rear frame 39.

As shown in FIG. 5, the front-rear frame 39 extends along the front-rear direction on the left side of the upper part of the housing 25. The rear end of the front-rear frame 39 is joined to the middle part along the top-bottom direction of the left end of the foregoing rear support frame 35. On the other hand, the front end of the front-rear frame 39 is located in front of a PCU-side terminal box 56 (described later) of the PCU 5 in the front-rear direction.

The top-bottom frame 40 extends downward from the front end of the front-rear frame 39. The left end of the front support frame 34 is joined to the lower part of the top-bottom frame 40. The lower end of the top-bottom frame 40 forms a leg portion 41 bent toward the outer side (left side) in the left-right direction with respect to the PCU 5. The unit support frame 31 is fixed to the frame member of the vehicle body 2 with the leg portion 41 therebetween.

### PCU

As shown in FIGS. 2 to 5, the foregoing housing 25 of the PCU 5 includes an upper case 51, a lower case 52 disposed under the upper case 51, and a heat sink housing 53 that separates the upper case 51 and the lower case 52 from each other, and is divided into three tiers along the top-bottom direction.

The upper case 51 is made of an aluminum material or the like, and has a rectangular frame-like shape that opens along the top-bottom direction. The upper opening thereof is covered by an upper cover 54. A control device is housed in the upper case 51.

A PCU-side terminal box 56 is formed on a side wall part (first side) 55a of the peripheral wall 55 of the upper case 51 located on one side (left side) in the left-right direction, so as to face the outer side (left side) in the left-right direction. A plurality of motor harnesses 57 (see FIGS. 4 and 5) that connect the motor 4 and the PCU 5 in each phase are attached to the PCU-side terminal box 56.

The motor harnesses 57 are arranged along the side wall part 55a in the front-rear direction. First ends of the motor harnesses 57 are attached to the inside of the PCU-side terminal box 56 from below, and are electrically connected to the control devices in the PCU 5 through a plurality of bus bars (not shown) in the PCU-side terminal box 56. On the other hand, second ends of the motor harnesses 57 are attached to a motor-side terminal box (not shown) in the motor 4 (see FIG. 1), and are electrically connected to the motor 4 through a plurality of bus bars (not shown) in the motor-side terminal box.

As shown in FIG. 5, the middle parts along the extending direction of the motor harnesses 57 are held by the left side support frame 33 with a bracket 61 therebetween. Part of the bracket 61 located below the front-rear frame 39 and behind the top-bottom frame 40 is formed in a plate-like shape that extends along the direction in which the motor harnesses 57 are arranged, that is, the front-rear direction, and holds the motor harnesses 57. The bracket 61 is fixed to the top-bottom frame 40 at one end and is fixed to the front-rear frame 39 at the other end.

Two mounting pieces 62 are protruded toward the left side from the upper end of the PCU-side terminal box 56. The mounting pieces 62 are formed along the front-rear direction in the PCU-side terminal box 56. The mounting pieces 62 are fixed to the front-rear frame 39 from above.

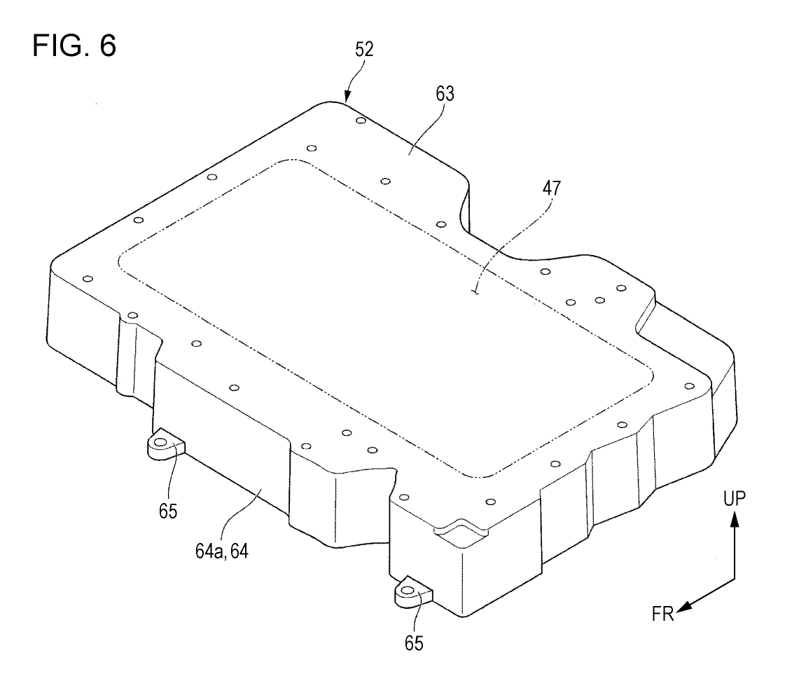

FIG. 6 is a top perspective view of the lower case.

As shown in FIGS. 2 and 6, the lower case 52 has a tubular shape having a top that opens downward, and is formed of the same material as that of the upper case 51 so as to have the same shape as the upper case 51 in plan view. A control device is fixed to the lower side of the top wall 63 of the lower case 52. The opening at the lower end of the lower case 52 is covered by a lower cover 66.

Two mounting pieces 65 are protruded toward the front from a front wall part (third side) 64a of the peripheral wall 64 of the lower case 52. The mounting pieces 65 are formed along the left-right direction, and the mounting pieces 65 are fixed to the front support frame 34 from above.

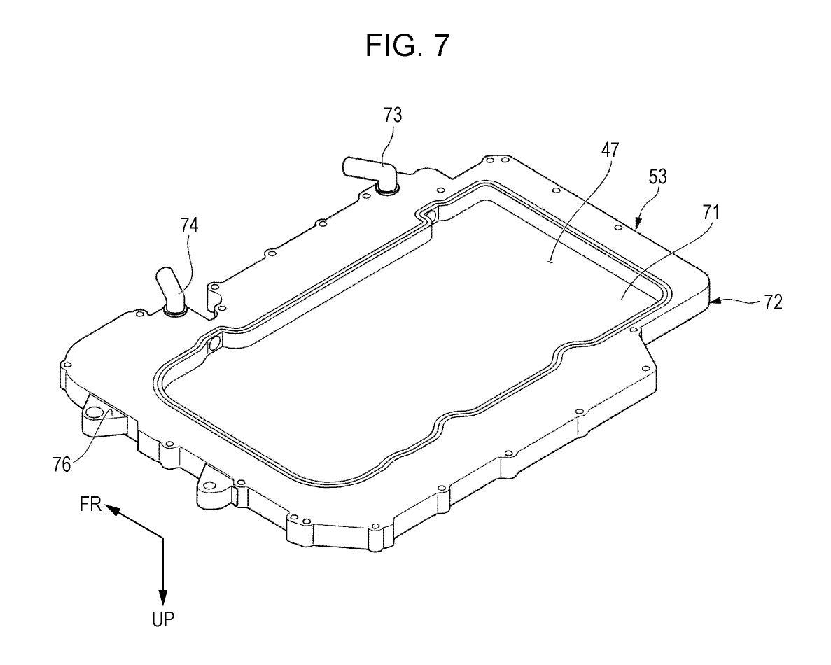

FIG. 7 is a bottom perspective view of the heat sink housing.

As shown in FIGS. 2 and 7, the heat sink housing 53 is made of an aluminum material and is more rigid than the foregoing frame member of the vehicle body 2 and the unit support frame 31. The heat sink housing 53 has a specific gravity (apparent specific gravity, the weight of the heat sink housing 53 or the case 51 or 52 divided by the weight of the same volume of water as the volume defined by the outer shape thereof) higher than those of the upper case 51 and the lower case 52. The heat sink housing 53 includes a rectangular plate-like partition 71 (see FIG. 7) having the same shape as the upper case 51 in plan view, and is provided so as to cover the opening at the lower end of the upper case 51. A control device is fixed to the upper surface of the partition 71.

A peripheral wall 72 surrounding the entire periphery of the partition 71 extends downward from the outer periphery of the partition 71. The lower end of the peripheral wall 72 is in contact with and fixed to the top wall 63 (see FIG. 63) of the foregoing lower case 52. The space surrounded by the top wall 63 of the lower case 52 and the partition 71 and the peripheral wall 72 of the heat sink housing 53 forms a water jacket 47 through which coolant flows. That is to say, in this embodiment, a water jacket 47 is disposed between the cases 51 and 52, and heat generated in the control devices housed in the upper case 51 and the lower case 52 is transferred to the water jacket 47.

A coolant inlet port 73 and a coolant outlet port 74 that connect the inside and outside of the water jacket 47 are arranged with a space therebetween in the left-right direction on the front edge of the peripheral wall 72. The coolant inlet port 73 is provided on the left side of the front edge of the peripheral wall 72, and the coolant outlet port 74 is provided on the right side. Coolant pipes (not shown) are connected to the distal ends of the ports 73 and 74, and coolant flows into and out of the water jacket 47 through the coolant pipes.

Two mounting pieces 76 are protruded toward the outer side (right side) in the left-right direction from the right edge (second side) of the peripheral wall 72. The mounting pieces 76 are formed along the front-rear direction, and the mounting pieces 76 are fixed to the right side support frame 32 from above.

A guard bracket 77 that covers the lower case 52 from the front is provided on the left side of a front wall part 64a of the lower case 52. The guard bracket 77 is a plate member made, for example, of iron, and inclines toward the rear as it extends from the lower end to the upper end. The upper end thereof is fastened to the front edge of the heat sink housing 53, and the lower end thereof is fastened to the front support frame 34. A cutout 78 that exposes the coolant inlet port 73 as viewed from the front-rear direction is formed in part of the guard bracket 77 overlapping with the coolant inlet port 73.

The left one of the foregoing mounting pieces 65 of the PCU 5 is disposed between places 79 at which the lower end of the guard bracket 77 is attached to the front support frame 34, in the left-right direction. Specifically, the mounting piece 65 is disposed behind the left part of the guard bracket 77, and the guard bracket 77 is disposed so as to cover the mounting piece 65 from the front.

As described above, in this embodiment, the unit support frame 31 is disposed in a position where it overlaps with the housing 25 of the PCU 5 in the top-bottom direction, and is disposed so as to surround the housing 25.

According to this configuration, the PCU 5 can be protected by the unit support frame 31. That is to say, if the impact load is input into the vehicle body at the time of impact, and if a peripheral member of the PCU 5 (for example, a low-voltage battery or an air compressor) is pushed toward the PCU 5, the movement of the peripheral member toward the PCU 5 can be prevented by the unit support frame 31. Thus, the peripheral member can be prevented from coming into contact with the PCU 5, and the damage of the PCU 5 can be prevented.

In addition, since the unit support frame 31 itself supporting the PCU 5 protects the PCU 5, the number of parts can be reduced compared, for example, to a case where a separate protecting member is attached.

In this embodiment, by disposing the unit support frame 31 in a position where it overlaps with the housing 25 of the PCU 5 in the top-bottom direction, the distance between each point at which the PCU 5 is fixed to the unit support frame 31 and the center of gravity of the PCU 5 can be reduced compared to a case where the PCU 5 is supported only in the lower part thereof. Therefore, the PCU 5 can be stably supported, and the stress acting on the fixing points (mounting pieces 62, 65, and 76) from the unit support frame 31 owing to the behavior of the electric vehicle 1 can be reduced.

In this embodiment, by disposing the heat sink housing 53 having a specific gravity higher than those of the upper case 51 and the lower case 52 between the upper case 51 and the lower case 52, the center of gravity of the housing 25 can be set at a higher position compared to a case where the heat sink housing 53 is disposed in the lower part. Therefore, the distance between each point at which the PCU 5 is fixed to the unit support frame 31 and the center of gravity of the PCU 5 can be further reduced.

Since the rigidity of the heat sink housing 53 is higher than those of the side frame of the vehicle body 2 and the unit support frame 31, the PCU 5 can be prevented from being damaged even if the impact load is transmitted to the heat sink housing 53.

By attaching the mounting pieces 62 of the upper case 51 to the left side support frame 33, the mounting pieces 76 of the heat sink housing 53 to the right side support frame 32, and the mounting pieces 65 of the lower case 52 to the front support frame 34, three sides of the unit support frame 31 are attached to different cases 51 and 52 and housing 53 of the housing 25. Therefore, the stress acting on the PCU 5 from the unit support frame 31 through the mounting pieces 62, 65, and 76 can be efficiently distributed to the cases 51 to 53. Therefore, the PCU 5 can be supported more stably.

The scope of the present disclosure is not limited to the foregoing embodiment, and various changes may be made in the foregoing embodiment without departing from the spirit of the present disclosure. Such changes are also included in the scope of the present disclosure. That is to say, the configuration and the like discussed in the foregoing embodiment are illustrative only, and changes may be made.

For example, the layout in the motor room 3, the configuration of the PCU 5, and the control devices housed in the PCU 5 may be changed.

As long as the unit support frame 31 is disposed in a position where it overlaps with the PCU 5 in the top-bottom direction so as to surround the PCU 5, the shape of the unit support frame 31 may be changed. That is to say, the position of the unit support frame 31 along the top-bottom direction may be changed within the height range of the PCU 5 in the top-bottom direction.

Although in the foregoing embodiment, the PCU 5 is disposed above the motor 4, the positional relationship between them may be changed.

In the above-described embodiments, the front and both sides of the housing 25 are fixed to the unit support frame 31. However, the present disclosure is not limited to this as long as different three sides are fixed. Alternatively, the four sides of the housing 25 may be fixed to the unit support frame 31.

The components in the foregoing embodiment may be replaced with known components without departing from the spirit of the present disclosure.

In a first aspect of the embodiment, there is provided a power control unit support structure of an electric vehicle (for example, the electric vehicle 1 in the embodiment) with which a power control unit (for example, the PCU 5 in the embodiment) is supported by a vehicle body (for example, the vehicle body 2 in the embodiment), the power control unit controlling power supplied from a battery and supplying the power to a motor (for example, the motor 4 in the embodiment), wherein the power control unit is supported by the vehicle body with a sub-frame (for example, the unit support frame 31 in the embodiment) therebetween, the sub-frame being separate from the vehicle body and detachably attached to the vehicle body, and wherein the sub-frame is disposed in a position where the sub-frame overlaps with the power control unit in the top-bottom direction, and is disposed so as to surround the power control unit as viewed from the top-bottom direction.

In a second aspect of the embodiment, the power control unit may include an upper case (for example, the upper case 51 in the embodiment) and a lower case (for example, the lower case 52 in the embodiment) in which control devices are housed, and a metal heat sink housing (for example, the heat sink housing 53 in the embodiment) that is disposed between the upper case and the lower case, on both upper and lower surfaces of which the control devices are disposed, and that exchanges heat with the upper case and the lower case. The heat sink housing may be more rigid than the vehicle body and the sub-frame. The power control unit may be formed in a quadrilateral shape as viewed from the top-bottom direction, the quadrilateral shape having four sides including a first side (for example, the side wall part 55a in the embodiment), a second side facing the first side, and a third side (for example, the front wall part 64a in the embodiment) different from the first side and the second side, the upper case being attached to the sub-frame on the first side, the heat sink housing being attached to the sub-frame on the second side, the lower case being attached to the sub-frame on the third side.

According to the first aspect of the embodiment, if the impact load is input into the vehicle body at the time of impact, and if a peripheral member of the power control unit is pushed toward the power control unit, the movement of the peripheral member toward the power control unit can be prevented by the sub-frame. That is to say, the power control unit can be protected by the sub-frame. Therefore, the peripheral member can be prevented from coming into contact with the power control unit, and the damage of the power control unit can be prevented.

In addition, since the sub-frame itself supporting the power control unit protects the power control unit, the number of parts can be reduced compared, for example, to a case where a separate protecting member is attached.

By disposing the sub-frame in a position where it overlaps with the power control unit in the top-bottom direction, the distance between each point at which the power control unit is fixed to the sub-frame and the center of gravity of the power control unit can be reduced compared to a case where the power control unit is supported only in the lower part thereof. Therefore, the power control unit can be stably supported, and the stress acting on the fixing points from the sub-frame owing to the behavior of the vehicle can be reduced.

According to the second aspect of the embodiment, three sides of the power control unit are attached to the sub-frame by different cases and heat sink housing. Therefore, the stress acting on the power control unit from the sub-frame through the mounting parts can be efficiently distributed to the cases and the heat sink housing. Therefore, the power control unit can be supported more stably.

Since the rigidity of the heat sink housing is higher than those of the vehicle body and the sub-frame, the power control unit can be prevented from being damaged even if the impact load is transmitted to the heat sink housing.

Obviously, numerous modifications and variations of the present invention are possible in light of the above teachings. It is therefore to be understood that within the scope of the appended claims, the invention may be practiced otherwise than as specifically described herein.

What is claimed is:

1. An electric vehicular power controller support structure comprising:
a sub-frame to support a power controller, the sub-frame being detachably attached to a vehicle body of an electric vehicle as a member separate from the vehicle body, the power controller being configured to control power supplied from a battery of the electric vehicle and configured to supply the power to a motor of the electric vehicle, the sub-frame being disposed to overlap with the power controller in a position of a top-bottom direction of the electric vehicle, the sub-frame being disposed to surround the power controller as viewed from the top-bottom direction.

2. The electric vehicular power controller support structure according to claim 1,
wherein the power controller includes an upper case, a lower case, a first control device, a second control device, and a heat sink housing, the first and second control devices being respectively housed in the upper and lower cases, the heat sink housing being made of metal and disposed between the upper case and the lower case to exchange heat with the first control device and the second control device,
wherein the heat sink housing is more rigid than the vehicle body and the sub-frame, and
wherein the power controller has a substantially quadrilateral shape as viewed from the top-bottom direction, the substantially quadrilateral shape having four sides including a first side, a second side opposite to the first side, and a third side different from the first side and the second side, the upper case being attached to the sub-frame on the first side, the heat sink housing being attached to the sub-frame on the second side, the lower case being attached to the sub-frame on the third side.

3. An electric vehicle comprising:
a power controller configured to control power supplied from a battery of the electric vehicle and configured to supply the power to a motor of the electric vehicle; and
a sub-frame to support the power controller, the sub-frame being detachably attached to a vehicle body of the electric vehicle as a member separate from the vehicle body, the sub-frame being disposed to overlap with the power controller in a position of a top-bottom direction of the electric vehicle, the sub-frame being disposed to surround the power controller as viewed from the top-bottom direction.

4. The electric vehicle according to claim 3, wherein the power controller includes an upper case, a lower case, a first control device, a second control device, and a heat sink housing, the first and second control devices being respectively housed in the upper and lower cases, the heat sink housing being made of metal and disposed between the upper case and the lower case to exchange heat with the first control device and the second control device.

5. The electric vehicle according to claim 4, wherein the heat sink housing is more rigid than the vehicle body and the sub-frame.

6. The electric vehicle according to claim 4, wherein the heat sink housing has a specific gravity higher than a specific gravity of the upper case and a specific gravity of the lower case.

7. The electric vehicle according to claim 4,
wherein the power controller includes
a first lateral face,
a second lateral face opposite to the first lateral face as viewed from the top-bottom direction,
a third lateral face, and
a fourth lateral face opposite to the third lateral face as viewed from the top-bottom direction, the first to fourth lateral faces providing a substantially quadrilateral shape as viewed from the top-bottom direction, and
wherein the sub-frame includes
a first frame provided along the first lateral face as viewed from the top-bottom direction,
a second frame provided along the second lateral face as viewed from the top-bottom direction, and
a third frame provided along the third lateral face as viewed from the top-bottom direction.

8. The electric vehicle according to claim 7,
wherein the upper case is attached to the first frame,
wherein the heat sink housing is attached to the second frame, and
wherein the lower case is attached to the third frame.

9. The electric vehicle according to claim 7, wherein the sub-frame includes a fourth frame provided along the fourth lateral face as viewed from the top-bottom direction.
